(19) United States
(12) Patent Application Publication
(10) Pub. No.: US 2006/0071432 A1
(43) Pub. Date: Apr. 6, 2006

(54) Seal for trocar

(76) Inventor: Rupert A. Staudner, Marathon, FL (US)

Correspondence Address: Kimberly Luna, Paralegal;Allegiance Corporation, 1430 Waukegan Road, McGaw Park, IL, 60085, US

(21) Appl. No.: 10/952,991

(22) Filed: Sep. 29, 2004

(51) Int. Cl. F16J 15/02

(52) U.S. Cl. 277/630

(57) ABSTRACT

A seal for use with a trocar. The seal includes a first portion terminating in a proximal end, a second portion terminating in a distal end, and a connecting region disposed between the first and the second portion. At least one longitudinal slit extends from the connecting region toward one of the proximal end, toward the distal end, or toward both. When the seal is in an unstressed state, the seal provides a fluid barrier and when the seal is in a stressed state, the at least one longitudinal slit opens to provide access to the inner portion of the seal.

The invention relates to a seal useable with a trocar for introducing surgical instruments, guidewires, dilators, catheters, or similar instruments into a patient. The seal is in a closed (or sealed) position when no instrument is inserted in the seal (i.e., when the seal is in an unstressed condition) and is opened when an instrument is inserted in the seal (i.e., a stressed condition).

A trocar is a surgical instrument that is used to gain access to a body cavity to perform, for example, laparoscopic or arthroscopic surgery and endoscopic procedures. In order to penetrate the skin and underlying tissue, the distal end of the obturator has a sharp point or cutting edge at its distal end. By applying pressure against the proximal end of the obturator, the sharp point is forced through the skin until it enters the body cavity. The trocar tube is inserted through the perforation made by the obturator and the obturator is withdrawn, leaving the trocar tube as an access way to the body cavity.

A housing that defines a chamber having an open distal end portion that communicates with the interior lumen defined by the trocar tube typically adjoins the proximal end portion of the trocar tube. An obturator and other surgical implements or tools axially extend into and are withdrawn from the trocar tube through the distal end portion of the chamber. It is the present practice to provide the chamber with a sealing means, such as a sealing grommet or gasket, through which the obturator or other implements extend.

Seals for trocars are known and two examples of such are described in U.S. Pat. No. 5,350,364 and U.S. Pat. No. 5,788,676. In U.S. Pat. No. 5,350,364, the seal has a generally hourglass shape that defines converging and diverging sidewalls that form a constricted center bore. The seal is open when no instrument is present and the seal acts against the instrument after the instrument is inserted to form a fluid (gas or liquid) seal. To minimize or control the deflection of the seal, a rib cage is provided on the outer surface of the seal.

U.S. Pat. No. 5,788,676 describes a seal having a pair of conical shapes joined at their tips by a cylindrical member. The seal has a number of slits from one end toward the other. When an instrument is inserted, a compressible member that acts on the outer portion of the conical shapes and cylindrical member to provide a fluid seal biases the seal to a contracted or closed position. This patent also describes that the seal can be biased by the compressible member to a closed or fluid sealing position when no instrument is inserted.

The art therefore teaches a seal that provides a fluid (gas or liquid) seal when an instrument is inserted into or longitudinally through the seal. The present seal, on the other hand, seeks to provide a zero closure seal that does not provide a fluid (gas or liquid) seal when an instrument is present in the seal (i.e., in the stressed condition), which allows an instrument to be easily inserted and removed from the seal.

### SUMMARY

The present invention is an introducer valve or zero closure seal for a trocar that provides a fluid (gas or liquid) seal in an unstressed condition, i.e., when there is no instrument present in the valve or seal and does not provide a fluid (gas or liquid) seal in a stressed condition, i.e., when an instrument is present. The seal may be formed from an expandable, stretchable, and/or elastic material such as an elastomeric material, rubber, latex, silicone, and other known materials.

The seal has a first portion and a second portion with a connecting region interposed between the two portions. The first portion is defined between the proximal end and the connecting region and the second portion is defined between the distal end and the connecting region. The first portion of the seal may have any suitable shape such as duckbill, conical, pyramidal, or multisided (3, 4, 5, etc.). Likewise, the second portion of the seal may have any suitable shape such as duckbill, conical, pyramidal, or multisided (3, 4, 5, etc.). In one embodiment, the seal tapers inwardly from the proximal end to the connecting region and tapers outwardly from the connecting region to the distal end such that it may resemble an hourglass from one side. Typically, the first and second portion will have the same shape and the first and second portion may have the same size, although it is not necessary.

At least one, and desirably, more than one, longitudinal slit is provided in the seal. The longitudinal slit extends from the connecting region toward one of the proximal end or the distal end or both. The longitudinal slit, however, does not extend the entire length to intersect the proximal end or the distal end. The longitudinal slit may be provided at any desirable location on the circumference of the seal. If the first or second portion is multisided, it may be convenient to provide the slit at an edge of a side.

The presence of the longitudinal slit(s) allows the seal to easily open when an instrument is inserted into or withdrawn from the seal; yet allows the seal to be in a closed condition when no instrument is present. In other words, although the connecting region can surround a penetrating instrument, the seal does not provide a fluid seal when an instrument is present, i.e., when the seal is in a stressed condition.

The seal may be provided with one or more stiffeners that can be disposed on the outer surface of the seal or within the material forming the seal. The stiffeners are generally oriented longitudinally along substantially the entire length of the seal to establish and/or maintain the seal in a closed position when the seal is in an unstressed condition.

As noted above, the seal is useful with a trocar and therefore, in one aspect, a trocar is provided that includes a seal according to the present invention.

### BRIEF DESCRIPTION OF THE DRAWINGS

FIG. 1 is a perspective view of one embodiment of the seal according to the present invention and with the seal in an unstressed condition.

FIG. 2 is a perspective view of the embodiment of the seal of FIG. 1 and with the seal in a stressed condition, i.e., with an instrument inserted into the seal.

FIG. 3 is a cross-sectional view of the seal shown in FIG. 1, along line 3-3.

FIG. 4 is a cross-sectional view of the seal shown in FIG. 1, along line 4-4.

### DESCRIPTION

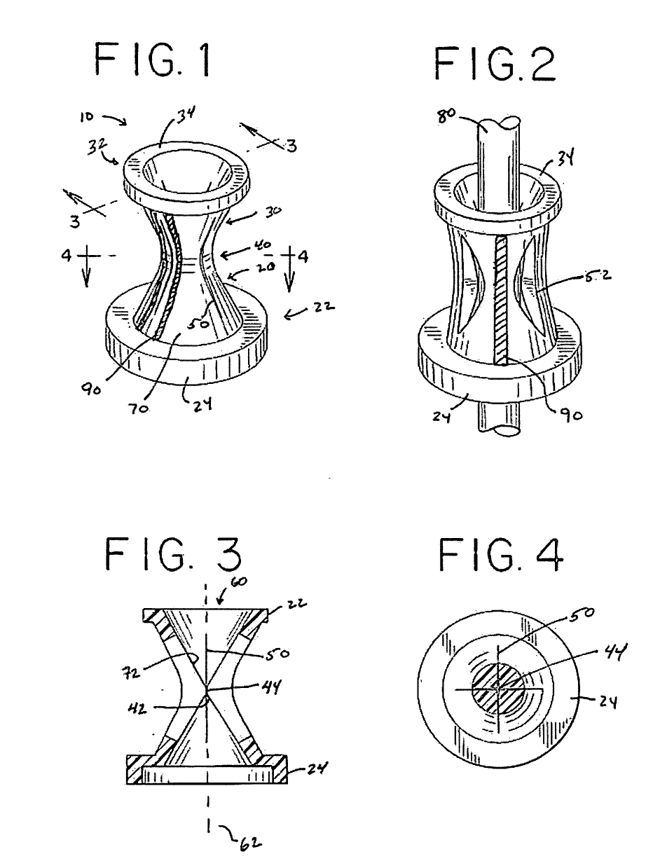

Turning now to FIG. 1, a seal 10 that is usable with a trocar (not shown) is depicted. The seal 10 has a first portion 20, a second portion 30, and a connecting region 40 disposed between and connecting the first portion 20 and the second portion 30. The first portion 20 is defined between the connecting region 40 and the proximal end 22. The second portion 30 is defined between the connecting region 40 and the distal end 32. The seal 10 is also provided with at least one longitudinal slit 50. When the seal 10 is in a stressed condition, a central longitudinal passageway 60 is provided a central longitudinal axis 62.

The proximal end 22 may terminate in a proximal rim or flange 24. Likewise, the distal end 32 may terminate in a distal rim or flange 34. The proximal flange 24 and the distal flange 34 may have any suitable size and may have a circumference that closely approximates the inner circumference of the housing. In such an instance, the rims or flanges 24, 34 may help to support or locate the seal 10 within the trocar housing (not shown). In this regard, it may be desirable if the proximal flange 24 had a greater outer diameter or circumference than the distal flange 34. By providing this difference in size, the distal flange 34 can float within the trocar housing. As a result, fluid that is present in the trocar housing and that is moving from the distal end 32 toward the proximal end 22 of the seal 10 will assist in closing or sealing the longitudinal slits 50, when the seal 10 is in the unstressed condition.

Alternatively, the distal flange 34 can have the same size as the proximal flange 24. If the distal flange 34 has approximately the same outer circumference as the inner circumference of the housing, then it is desirable if the distal flange 34 is provided with one or more gaps or holes to allow fluid to move from the distal end 32 toward the proximal end 22 and thus apply pressure on the outer portion of the seal between the distal end 32 and the proximal end 22 to assist in closing or sealing the longitudinal slits 50, when the seal 10 is in the unstressed condition.

Although each of the rims or flanges 24, 34 can have the same circumferential shape as the first 20 and second 30 portions of the seal 10, it is desirable if the rims or flanges 24, 34 have a circular shape. By providing a circular shape, the seal 10 can be used with the known trocars, which typically have a cylindrical shape.

The first portion 20 of the seal may have any suitable shape such as duckbill, conical, pyramidal, or multisided (3, 4, 5, etc.). Likewise, the second portion 30 of the seal may have any suitable shape such as duckbill, conical, pyramidal, or multisided (3, 4, 5, etc.). Typically, the first 20 and second 30 portion will have the same shape, although it is not necessary. Likewise, the first 20 and second 30 portion may have the same size, although it is not necessary. In one embodiment, the exterior surface 70 (and the interior 72 surface when the seal 10 is in an unstressed condition) of the seal 10 tapers inwardly from the proximal end 22 to the connecting region 40 and tapers outwardly from the connecting region 40 to the distal end 32 such that it may resemble an hourglass from one side.

As noted above, the seal 10 may have a duck bill shape. Accordingly, just below the proximal flange 24, the first portion 20 may be provided with opposite walls that are planar and converge downwardly toward the connecting region 40. Beginning at the connecting region 40, the second portion 30 may be provided with opposite walls that diverge outwardly and downwardly from the first portion planar walls to terminate just before the distal flange 34. The second portion planar walls comprise return panels that protect the integrity of the seal formed in the connecting region by resisting the tendency of instruments to disturb the seal by inverting the first portion planar walls when passing through the seal 10.

The inner surface 72 of the seal and, in particular, the portion where the inner surface of the connecting region 42 abuts defines a seal slit 44 that is closed when the seal 10 is in the unstressed condition, as shown in FIG. 3. The seal slit 44 will generally have a shape that is defined by the shape of the first portion 20 and the second portion 30. Therefore, depending on the geometry of the first 20 and second 30 portions, the seal slit 44 may extend straight across the seal 10 or it may come to a point, or be curved, Y-shaped, X-shaped, or the like. For example, as best seen in FIG. 4, four sides are provided and the seal slit 44 comes to a point.

The seal 10 is also provided with at least one longitudinal slit 50 that extends from the exterior surface 70 through the interior surface 72. The longitudinal slit 50 may extend from the connecting region 40 toward one of the proximal end 22 or toward the distal end 32 or both. The longitudinal slit 50 does not extend the entire length to intersect the proximal end 22 or the distal end 32. Accordingly, the longitudinal slit 50 does not intersect the proximal flange 24 or the distal flange 34, if present.

The longitudinal slit 50 may be provided at any desirable location on the circumference of the seal 10. If the first portion 20 or second portion 30 is multisided, it may be convenient to provide a slit 50 at an edge of a side. The longitudinal slit 50 allows the connecting region 40 to more easily deform and outwardly expand when the seal 10 is in a stressed condition. Desirably, the seal 10 is provided with two longitudinal slits 50, with the slits 50 being opposite each other. More desirably, the seal 10 is provided with four longitudinal slits 50.

The presence of the slit(s) 50 allows the seal 10 to easily open when an instrument 80 is inserted into or withdrawn from the seal; yet allows the seal 10 (and the seal slit 44) to be in a closed condition when no instrument 80 is present. In other words, although the connecting region 40 can surround a penetrating instrument 80, the seal 10 does not provide a fluid seal when an instrument 80 is present, i.e., when the seal 10 is in a stressed condition.

The seal 10 will generally be compliant enough to allow an instrument 80 to pass through the seal 10, and sufficiently resilient to return to its original shape once the instrument 80 is removed. In this regard, the seal 10 is formed of a material that, when the seal 10 is in an unstressed condition, the inner surface 72 of the seal and, in particular the seal slit 44 will be in a closed sealing position. At the same time, the seal 10 will generally be capable of easily passing any instrument 80 having the desired size. Typically, instruments 80 used with the seal 10 will have a size in the range from about 5.0 mm to about 10 mm in diameter.

The seal 10 is typically a one-piece assembly with a wall thickness sufficient to withstand and maintain peritoneal overpressure within the trocar shell. The seal 10 may be formed of an expandable, stretchable, and/or elastic material such as an elastomeric material, polyurethane, nitrile, thermoplastic elastomer, rubber, latex, silicone and other known materials. The seal 10 may be formed from an elastic material having a Shore hardness of about 20 to about 50.

The seal 10 may be provided with one or more stiffeners 90 that can be disposed on a surface of the seal or within the material forming the seal 10. The stiffeners 90 are generally oriented longitudinally along substantially the entire length of the longitudinal slit 50 and may extend the entire length of the seal 10 or to the flanges 24, 34. The stiffeners 90 aid in establishing or maintaining the seal 10 in a closed position when the seal 10 is in an unstressed condition. The stiffeners 90 can be located adjacent the edge of the longitudinal slit 50, as shown in FIG. 1 or in the area between two longitudinal slits 50, as shown in FIG. 2. The stiffeners 90 can then aid in maintaining the longitudinal slits 50 and the seal slit 44 in a substantially closed or a closed position when the seal 10 is in an unstressed condition.

Alternatively, the seal 10 may be provided with varying wall thicknesses strategically located to aid in moving or maintaining the longitudinal slits 50 in a closed or substantially closed position.

The length of the seal 10 may be configured to engage a valve body provided within the trocar housing. The seal 10 may be symmetrical in relation to its longitudinal axis 62, to exert equal push and pull forces upon the instrument 80 and to ensure that the valve body cannot be incorrectly assembled. It is not necessary, however, that the seal 10 be symmetrical or that the first portion 20 and the second portion 30 converge at the center of the seal 10.

The inner surface 72 of the seal may be coated with a lubricant such as a hydrogel material or silicon to minimize or reduce the frictional forces while inserting or moving instruments inside the seal 10.

Referring now to FIG. 2, as a penetrating instrument 80 such as a guidewire or other instrument is inserted into the seal 10, the connecting region 40 and the seal slit 44 expand to define a stressed condition of the seal 10. At the same time, the longitudinal slits 50 expand such that the edges 52 of the longitudinal slits are disposed away from each other. As a result, the seal 10 allows passage of fluids through the longitudinal slits 50.

It is to be understood that, while the invention has been described above in conjunction with the specific embodiments, the description is intended to illustrate and to limit the scope of the present invention, which is defined by the scope of the claims.

1. A seal for use with a trocar comprising:
a. a first portion terminating at a proximal end, a second portion terminating at a distal end, and a connecting region disposed between the first portion and the second portion;
b. at least one longitudinal slit extending from the connecting region toward one of the proximal end or the distal end, wherein in an unstressed condition, an interior of the seal provides a fluid barrier and in a stressed condition, the interior of the seal allows fluid to pass through the seal.

2. The seal of claim 1 wherein the first portion is inwardly tapered from the proximal end to the connecting region and wherein the second portion is inwardly tapered from the distal end to the connecting region.

3. The seal of claim 2 wherein each of the first portion and the second portion has a conical, pyramidal, triangular, or multisided shape.

4. The seal of claim 2 wherein each of the first portion and the second portion has a multisided shape.

5. The seal of claim 3 wherein the first portion and the second portion have substantially the same shape.

6. The seal of claim 1 wherein the at least one longitudinal slit extends from the connecting region toward the proximal end and from the connecting region toward the distal end.

7. The seal of claim 4 wherein the at least one longitudinal slit is provided on an edge of one of the first portion or the second portion.

8. The seal of claim 1 having two longitudinal slits.

9. The seal of claim 1 having four longitudinal slits.

10. The seal of claim 1 further comprising at least one longitudinal stiffener adjacent at least one of the at least one longitudinal slit.

11. The seal of claim 8 further comprising at least one longitudinal stiffener disposed between the two longitudinal slits.

12. The seal of claim 9 further comprising at least one longitudinal stiffener disposed between adjacent longitudinal slits.

13. The seal of claim 1 wherein the first portion is substantially the same size as the second portion.

14. The seal of claim 1 further comprising a flange on the proximal end and a flange on the distal end.

15. The seal of claim 14 wherein the proximal flange has a circumference greater than a circumference of the distal flange.

16. A seal for use with a trocar comprising:
a. a first portion having one of a pyramidal shape or a conical shape with its base at a proximal end of the seal;
b. a second portion having one of a pyramidal shape or a conical shape with its base at a distal end of the seal;
c. a connecting region disposed between the first portion and the second portion;
d. at least one longitudinal slit extending from the connecting region toward one of the proximal end or toward the distal end; wherein when the seal is in an unstressed condition, the at least one longitudinal slit is in a closed position and when the seal is in a stressed condition, the at least one longitudinal slit is in an open position.

17. The seal of claim 16 further comprising a substantially circular flange on the proximal end and a substantially circular flange on the distal end.

18. The seal of claim 17 wherein the proximal flange has a circumference greater than the distal flange.

19. The seal of claim 16 further comprising at least one longitudinal stiffener disposed adjacent the at least one longitudinal slit.

20. The seal of claim 16 wherein each of the first portion and the second portion has a conical shape.

21. The seal of claim 16 wherein the at least one longitudinal slit extends from the connecting region toward the proximal end and from the connecting region toward the distal end.

22. The seal of claim 16 wherein the connecting region includes an inner seal slit.

23. The seal of claim 22 wherein the inner seal slit has a shape of a point.
